(19) United States
(12) Patent Application Publication
(10) Pub. No.: US 2002/0198795 A1
(43) Pub. Date: Dec. 26, 2002

(54) Home inventory management system and method

(76) Inventor: Jheroen Pieter Dorenbosch, Paradise, TX (US)

Correspondence Address: MOTOROLA INC, 600 NORTH US HIGHWAY 45, LIBERTYVILLE, IL, 60048-5343, US

(21) Appl. No.: 10/234,749

(22) Filed: Sep. 4, 2002

Related U.S. Application Data
(62) Division of application No. 09/624,645, filed on Jul. 25, 2000.

(51) Int. Cl. G06F 17/60

(52) U.S. Cl. 705/28

(57) ABSTRACT

A system for maintaining an inventory of items in a facility. Each item has attached thereto an identification tag containing item information about the item. An identification tag reader at an entrance portal of the facility reads item information for each item entering the facility through the entrance portal. A computer maintaining an inventory database of items in the facility updates the inventory database in accordance with the item information read by the identification tag reader.

### FIELD OF THE INVENTION

The present invention relates to systems and methods for inventory tracking and more particularly such system and methods for managing and tracking inventory.

### BACKGROUND OF THE INVENTION

The residents of a home or household regularly purchase a variety of items for use and consumption in the household. Such purchased items include groceries (food) and other supplies, such as trash bags, cleaning supplies, toiletries, and the like. This is typically done by a member of the household shopping in a brick-and-mortar store such as a grocery store, or via on-line shopping. Such items are typically stored in various storage areas inside the residence (e.g., refrigerator, freezer, cabinets, pantry) until consumed, removed, or discarded. The current stock of items constitutes the household's current inventory of such items.

The residents do not always know what items are available or which are needed. For example, a person may wish to cook dinner using a recipe that requires onions, but he may discover that no onions are present in the inventory, or that the available onions are spoiled. Thus, the person must abandon the desired meal and switch to a less-desirable or at least substitute course of action. If the person had recognized ahead of time that the household's supply of onions was low or needed replenishing, the onions may have been available for the desired purpose. Clearly a need exists for system and methods that solve the aforementioned or analogous problems.

### BRIEF DESCRIPTION OF THE DRAWINGS

These and other features, aspects, and advantages of the present invention will become more fully apparent from the following description, appended claims, and accompanying drawings in which:

FIG. 1 is a block diagram of a home inventory management system in accordance with an embodiment of the present invention; and

FIG. 2 is a flow chart illustrating a method of operation of the home inventory management system of FIG. 1.

### DETAILED DESCRIPTION OF THE PREFERRED EMBODIMENT

The present disclosure discusses apparatus and method for inventory management of various household items. In an embodiment, identification tags are attached to the items by for example a vendor, to identify and track the items.

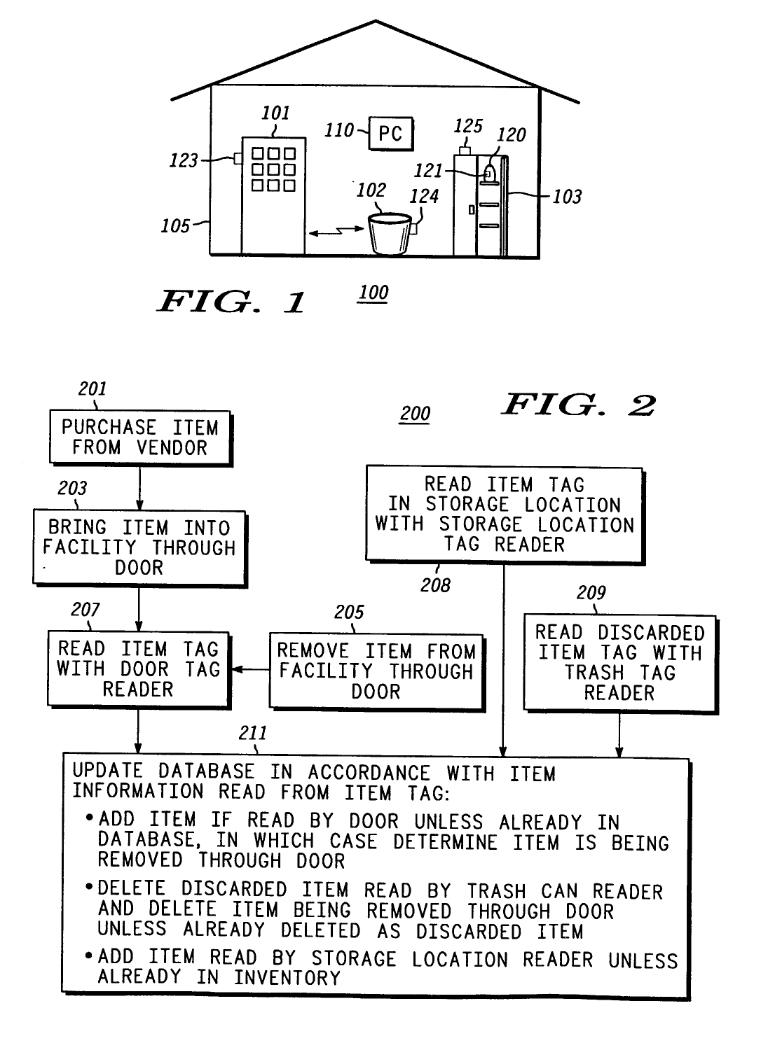

Referring now to FIG. 1, there is shown a block diagram of a home inventory management system 100 in accordance with an embodiment of the present invention. The components of system 100 are placed within a home 105, which may be any type of residence, dwelling, or facility, such as a house, apartment, workshop, or trailer. An inventory computer such as PC 110 is used to coordinate the inventory system. PC 110 is connected by wireless or other means to various tracking and sensing units, such as door 101, trash 102, and refrigerator 103. Referring now to FIG. 2, there is shown a flow chart 200 illustrating the method of operation of the home inventory management system 100 of FIG. 1.

In an embodiment, system 100 relies on the identification devices already placed on purchased items by the vendor or some other third party. For example, a gallon of milk 120 purchased from a grocery store has a specified type of identification tag 121 attached thereto, which may be used by the grocery store itself for inventory control, for automated checkout (purchase), and other purposes. The item 120 may be stored in a storage location such as refrigerator 103, for example, as illustrated. Thus, many purchased items in home 105 may come equipped with some sort of identification tag. These tags may be devices such as RF (radio-frequency) tags, and the like. Such identification tags may be sensed or “read” by appropriate detector devices to identify the identity of the item, or other information about the item which is stored in the tag.

RF tags, sometimes referred to as RF transponder tags, RF-ID (identification) tags (RF-IDs), or electronic barcodes, can be an active or passive device, and are typically attached to an item. A passive RF tag typically has a capacitor which can be charged when the device passes through or is subjected to a sufficient RF field, to power the device. An external RF reader device can read information from the RF tag, for example by sending a wireless query to RF tag, which responds with information such as the identify of the item, a password, or status.

Different types of RF tag systems are in use, for purposes such as production tracking, automatic toll collection, and anti-theft functions for consumer items. Many RF tags currently in use operate at relatively short distances, from a few inches to a few feet, while others operate from hundreds of feet to miles. Simple, inexpensive, passive RF tags used for anti-theft and product-identification purposes in stores, for example, are sometimes referred to as penny tags.

In one embodiment, system 100 is geared to management of groceries and other types of regularly purchased household items, which are purchased from a vendor which utilizes some type of identification tag system, so that items are purchased already having attached thereto an identification tag that may be exploited by inventory system 100 (FIG. 2, step 201). Such items typically enter the house through one or more doors or entry portals 101, are stored before use or expiration in a storage location such as a pantry, closet, cabinet, or refrigerator 103, and are eventually disposed of after use in one or more disposal receptacles 102.

Each of door 101, storage location 103, and disposal receptacle 102 may be considered to be an “item portal,” because purchased items pass through or are stored in these things. A door can be either an entry or exit portal. A trash receptacle is a type of exit portal because an item deposited in a trash receptacle should be considered to be removed from the inventory, like an item that exits the facility through a door. Storage locations or areas can be considered to be storage portals.

In an embodiment, each of these three types of item portals is equipped with one or more identification tag readers and is in communication with PC 110 to provide inventory control. For example, all or some entry/exit portals in the house may be equipped with an RF tag reader, in order to detect new (purchased) items, and items that are removed from the house via the door. Thus, door 101 has tag reader 123 attached to or incorporated in its frame, for example, for reading the tags of items entering or exiting the home 105 through the door 101. As recently-purchased groceries are brought into house 105 through door 101 (step 203), door 101 detects the identify of each item as it passes through sensors 123 in the door frame (step 207). Each detected item is added to an inventory stored in and maintained by PC 110 (step 211).

Similarly, if a previously-inventoried item is removed from house 105 via door 101 (step 205), it is identified (step 207) and removed from the inventory (step 211). In order for door 101 to be used to update the inventory database by both adding to it new items brought into the facility through the door, and deleting from it previously-inventoried items removed from the facility through the door, system 100 has to be able to distinguish between items brought into the facility and those leaving the facility. In one embodiment, each item has a unique identifier, e.g. a unique serial number stored in each item's RF tag. Thus, when door 101 reads a given item's identifier, system 100 checks to see if this item is already in the inventory database. If not, system 100 assumes the item is entering the facility and it is added to the inventory database. On the other hand, if the sensed identifier is already in the database, system 100 assumes the item is leaving the facility and it is deleted from the inventory database (step 211).

Similarly, trash or disposal 102 has tag reader 124 coupled thereto for reading tags of discarded items placed in the trash (step 209), and refrigerator 103 has one or more RF tag readers 125 installed therein for reading the RF tags of items currently inside the refrigerator (step 208). The items corresponding to the detected tags at the disposal 102 are deleted from the inventory (step 211).

In an embodiment, the inventory application running on PC 110 is designed to avoid double-counting items in the trash when the trash is removed from the house. For example, if an item has already been discarded in trash 120, it should already have been deleted from the inventory maintained by PC 110. If the trash is taken out of the house and passes through door 101, it would be possible for the door 110's reader 123 to detect the item leaving the house and to attempt to delete it from the inventory. Thus, in an embodiment, before deleting an item detected as exiting the house 105 through door 101, PC 110 compares the detected item against items previously deleted for being discarded, and only deletes the item if it has not already been deleted (step 211). Such an embodiment presupposes unique identifiers for each item, e.g. a unique serial number stored in each item's RF tag. In addition, if for some reason trash RF reader 124 did not detect a discarded item, door 101 may be able to detect the item and delete it, thus providing a backup function for trash 124.

A storage area such as a refrigerator 103 may also be equipped with sensors to validate the availability of items, for redundancy, monitoring, location identification, and the like. Thus, by employing sufficient sensors in storage areas, system 100 can know the location of at least some unconsumed items. Further, PC 110□s inventory management application can be designed to add a new item to the inventory which is detected inside refrigerator 103 or any other storage location, which was not already added when the item passed through door 101. Thus, storage locations and their RF tag readers can provide a backup function to doors 101, similar to the way in which doors 101 provide a backup function for trash 124, as described above. As with trash 124, however, to avoid double-counting and adding a new item twice to the inventory, a storage location detecting a “new” item only causes the new item to be added to the inventory if the door 101 has not already detected the item (step 211).

Thus, by employing system 100, PC 110 is able to maintain a continually updated inventory database corresponding to the currently available inventory of the type of purchased items that come equipped with detectable identification tags. As noted above, in an embodiment each RF tag can identify the type and nature of the item, but can do so in a unique way. For example, multiple items of the same type may be purchased (e.g., five packages of sausage). System 100 preferably has the ability to count all five items as they pass through door 101, even though the door would read the same “sausage” identifier from each tag. By recognizing and recording the unique serial number of each sausage pack, system 100 can recognize that there are five separate packages entering through door 101 more or less simultaneously.

PC 110 also processes and manages the inventory using a suitable inventory management application. In an embodiment, inventory management system 100 provides to the user upon request, or at regular intervals, a list of items to purchase, based on current inventory and past purchase and consumption trends. System 100 preferably establishes a baseline (normal) profile of items normally present in the home, and automatically adds items to a shopping list if the item is running low or will soon need to be replenished. In an embodiment, system 100 can be configured to automatically purchase, via on-line shopping, some or all of the needed items to replenish the inventory.

System 100 also preferably offers a variety of ancillary features related to the inventory management function. For example, system 100 permits a user to query system 100 as to whether all items necessary for a particular task (e.g., painting a wall, cooking a turkey) are available. For example, system 100 may know that putty, paint, and paint brushes are currently available, but that there is no sandpaper. If these four items are necessary and sufficient to perform a given paint job, the user is notified that sandpaper needs to be purchased. System 100 also can be configured to suggest what to cook for dinner based on available food items, user preferences, past meal history, time constraints, and so on.

System 100 can suggest optimal ways to accomplish a given task, taking into account available supplies needed for the task, or can indicate the minimum number of given items that need to be purchased in order to accomplish a specified task. In an embodiment, various residents of the household wear on-board computers or other type of detectable information device which can indicate, for example, what the person has eaten for lunch. System 100 may thus query the on-board computers of the household residents and suggest a meal based on the residents' recent meals and available food inventory.

In an embodiment, the door 101 and trash 102 communicate directly with each other to avoid over counting. In an alternative embodiment, each separate item portal communicates with PC 110, which takes into account new and discarded items, as noted above. A sufficient number of detectors are preferably in place inside home 105 to permit a volume inventory periodically or upon demand. Thus, detectors may be placed strategically in the home, e.g. within the most typically used storage receptacles, such as pantry, refrigerator, closets, garage/workshop, and kitchen cabinets. Such a system preferably is able to distinguish between items (tags) inside a disposal receptacle such as trash 102, and items outside such receptacles. In an embodiment, the volume inventory is performed in a hierarchical fashion, where every storage receptacle (e.g. cabinet/refrigerator/freezer) keeps its own local inventory, which may then be accessed by a query from PC 110 to update the global inventory.

As described above, each item's identification tag must be able to at least provide the identity of the item to a tag reader, preferably a unique identity. For example, a tube of toothpaste can be identified as “toothpaste tube,” and preferably as “toothpaste tube #XYZ” to distinguish it from other identical tubes of toothpaste and to permit counting of multiple items of the identical type. In an alternative embodiment, other information related to or about the item may be provided to a tag reader by an item's identification tag. For example, an expiration date of a gallon of milk may be provided by the item's tag. This can permit the inventory program to determine that the supply of milk needs to be replenished, even if the milk has not yet been used up. Alternatively, the inventory application can determine its own expiration dates by correlating the type of item read with an internal database. For example, if “bananas” or “onions” are detected, the inventory application running on PC 110 can indicate to the user that this item may be about to spoil a specified number of days after the item is first entered into the inventory. In addition, the expiration date of an item can be estimated by taking into account the item's location and storage conditions, e.g. whether and for how long it has been refrigerated or not.

The present invention has been described with respect to an implementation in a residential building such as a home or workshop. In general, the present invention may be employed for inventory management of an inventory of items stored in any facility, meaning a building or enclosed volume having storage areas for an inventory of items brought into the facility through one or more entry portals, where the items come already equipped with readable identification tags from the vendor or other item source.

In alternative embodiments, instead of RF tags, any other readable identification tag or device may be employed, which can be read by wireless means. For example, a magnetic electronic article surveillance (EAS) tag may also be used, instead of a conventional “penny” type RF tag. EAS tags typically employ the Barkhausen jump effect, which is characterized by a tendency for magnetization induced in a magnetic material to change in discrete steps as an external magnetic field is increased or decreased.

It will be understood that various changes in the details, materials, and arrangements of the parts which have been described and illustrated above in order to explain the nature of this invention may be made by those skilled in the art without departing from the principle and scope of the invention as recited in the following claims.

What is claimed is:

1. A system for maintaining an inventory of items in a facility, comprising:
(a) an identification tag reader at an entrance portal of the facility, wherein each item has attached thereto an identification tag containing item information about the item, wherein the identification tag reader is for reading item information for each item entering the facility through the entrance portal; and
(b) a computer for maintaining an inventory database of items in the facility, wherein the computer is operatively connected to the identification tag reader and is for receiving the item information from the identification tag reader and for updating the inventory database in accordance with said item information.

2. The system of claim 1, further comprising a trash identification tag reader for reading discarded item information from identification tags of discarded items placed in a trash receptacle, wherein the computer is operatively connected to the trash identification tag reader and is for receiving the discarded item information from the trash identification tag reader and for updating the inventory database in accordance with said discarded item information.

3. The system of claim 2, wherein:
the entrance portal is a door; and
the computer:
adds a new item entering the facility through the door to the inventory database;
deletes a discarded item from the inventory database; and
deletes an item leaving the facility through the entrance portal from the inventory database unless the item is a discarded item.

4. The system of claim 1, wherein:
the entrance portal is a door; and
the computer:
adds an item detected by the identification tag reader to the inventory database unless the item is already in the inventory database; and
deletes an item from the inventory database if it is detected by the identification tag reader when the item is already in the inventory database.

5. The system of claim 1, further comprising a storage location identification tag reader for reading stored item information from identification tags of stored items contained in a storage location within the facility, wherein the computer is operatively connected to the storage location identification tag reader and is for receiving the stored item information from the storage location identification tag reader and for updating the inventory database in accordance with said stored item information.

6. The system of claim 1, wherein the entrance portal is a door.

7. The system of claim 1, wherein the identification tags are RF tags and the identification tag reader is an RF tag reader.

8. The system of claim 1, wherein the computer comprises at least one of:
(a) means for using the inventory database to identify missing items which are required to accomplish a specified task;
(b) means for determining, from a plurality of options, those choices for which all required items are in the inventory; and
(c) means for determining an expiration date for an item and for informing a user that the item has expired or is about to expire based on the expiration date of the item and the storage conditions of the item.

9. The system of claim 1, wherein the items are purchased from a vendor having the identification tags already attached thereto.

10. The system of claim 1, wherein the facility is a home.

11. A method for maintaining an inventory of items in a facility, comprising the steps of:
(a) bringing items into the facility through an entrance portal, wherein each item has attached thereto an identification tag containing item information about the item;
(b) reading, with an identification tag reader at the entrance portal, item information for each item entering the facility through the entrance portal; and
(c) updating an inventory database of items in the facility in accordance with said item information.

12. The method of claim 11, further comprising the step of acquiring the items from a source before bringing the items into the facility.

13. The method of claim 11, further comprising the steps of maintaining and updating the inventory database with a computer operatively connected to the identification tag reader for receiving the item information from the identification tag reader.

14. The method of claim 13, further comprising the step of reading discarded item information from identification tags of discarded items placed in a trash receptacle, receiving the discarded item information from the trash identification tag reader and updating the inventory database in accordance with said discarded item information.

15. The method of claim 14, wherein:
step (a) comprises the step of bringing items into the facility through a door, the method further comprising the steps of:
adding to the inventory database a new item entering the facility through the door;
deleting from the inventory database a discarded item; and
deleting from the inventory database an item leaving the facility through the entrance portal unless the item is a discarded item.

16. The method of claim 13, wherein:
step (a) comprises the step of bringing items into the facility through a door, the method further comprising the steps of:
adding to the inventory database an item detected by the identification tag reader unless the item is already in the inventory database; and
deleting an item from the inventory database if it is detected by the identification tag reader when the item is already in the inventory database.

17. The method of claim 13, further comprising the step of reading, with a storage location identification tag reader, stored item information from identification tags of stored items contained in a storage location within the facility, wherein the computer is operatively connected to the storage location identification tag reader and is for receiving the stored item information from the storage location identification tag reader and for updating the inventory database in accordance with said stored item information.

18. The method of claim 11, wherein step (a) comprises the step of bringing items into the facility through a door.

19. The method of claim 11, wherein each item has attached thereto an RF tag containing item information about the item.

20. The method of claim 11, further comprising the step of purchasing the items from a vendor, having the identification tags already attached thereto, before bringing the items into the facility, wherein the facility is a home.
